(19) United States
(12) Patent Application Publication
(10) Pub. No.: US 2023/0077230 A1
(43) Pub. Date: Mar. 9, 2023

(54) AUTONOMOUS AIRBORNE MISSION NAVIGATION AND TASKING SYSTEM

(71) Applicant: Government of the United States, as represented by the Secretary of the Air Force, Wright-Patterson AFB, OH (US)

(72) Inventors: Trevor Bihl, Franklin Furnace, OH (US); Chadwick Cox, Madison, AL (US)

(21) Appl. No.: 17/899,244

(22) Filed: Aug. 30, 2022

Related U.S. Application Data
(60) Provisional application No. 63/238,517, filed on Aug. 30, 2021.

(51) Int. Cl. G05D 1/00; B64C 39/02; G05D 1/10

(52) U.S. Cl. CPC G05D 1/0088; B64C 39/024; G05D 1/101; B64C 2201/141

(57) ABSTRACT

An autonomous mission selection process for improving performance, the process using an Observe, Orient, Decide, and Act model wherein sensors are used for observing a situation and guiding initial mission planning. Aa machine cognitive re-planner assesses inputs, orients, and replans operations including deciding on a payload and determining a route and autonomously acting to direct the mission selected.

### CROSS-REFERENCE TO RELATED APPLICATIONS

This application claims the benefit of priority under 35 U.S.C. § 119(e) to U.S. Provisional Application Ser. No. 63/238,517 entitled “Autonomous task selection considered via switching system”, filed 30 Aug. 2021, the contents of which are incorporated herein by reference in their entirety.

### ORIGIN OF THE INVENTION

The invention described herein was made by employees of the United States Government and may be manufactured and used by or for the Government of the United States of America for governmental purposes without the payment of any royalties thereon or therefore.

### BACKGROUND

### 1. Technical Field

The present disclosure generally relates to aircraft navigation systems, and more particularly to autonomous drone aircraft navigation systems.

### 2. Description of the Related Art

Unmanned systems are finding use in a variety of applications including commercial, personal, and government/military. As conceptualized in FIG. 3A (prior art), human interaction with unmanned systems occurs along a spectrum from full human control to the objective of a fully autonomous system. In operating any unmanned system, interactions exist between the platform's actuators and the desired goals. Thus, throughout the spectrum, planning is a necessary component to enable an unmanned system to operate effectively. The capability to autonomously plan, monitor, re-plan, and coordinate activities is an objective of United States Air Force (USAF) research where machine planners are largely autonomous. However, progress towards autonomy has been incremental with key differences between automation and autonomy missing, including 1) improve their ability to handle uncertain and unexpected situations, 2) build in self-directed behavior, and 3) include intelligent, informed, unforced choice. To these ends, AFRL researchers herein provide automatons behaviors with flexible cognitive capabilities to adapt to a wide variety of tasks and to coordinate with other aircraft, ground craft, and the like.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 illustrates a diagram of a planning stack, according to one or more embodiments;

FIG. 2 depicts the diagram that conceptualizes a dynamic replanning autonomy service (DRAS) process;

FIG. 3A depicts a diagram of Planning and Re-planning today;

FIG. 3B depicts a diagram of Planning and Re-planning that incorporates an autonomous reasoner and machine cognitive re-planner reasoner; today; and

FIG. 4 depicts a map of the Big Island of Hawaii.

### DETAILED DESCRIPTION

Unmanned Aerial Vehicles (UAVs) provide rapid exploration capabilities in search and rescue missions while accepting more risks than human operations. One limitation is that current UAVs are heavily manpower intensive and such manpower demands limited abilities to expand UAV use. In operation, manpower demands for UAVs include determining tasks, selecting waypoints, manually controlling platforms and sensors, and tasks between the beginning and the end of a mission or task. Often, even a high level of autonomy is possible with human generated objectives and then autonomous resource allocation, routing, and planning. However, manually generating tasks and scenarios is still manpower intensive. To reduce manpower demands and move towards more autonomous operations, the authors develop a reasoning system that takes high level goals from a human operator and translates them into situationally relevant tasking. For expository simulation, a scenario drawn from the 2018 Hawaii Puna lava natural disaster is here in analyzed as an example.

Unmanned aerial vehicles (UAVs) are seeing increasing use in search and rescue missions due to their ability to physically cover more area than humans alone as well as their ability to survey dangerous areas. However, despite the operators being at a distance, manpower demands are pervasive for UAV operations. While in layman's terms they might be considered as “autonomous” due to them not being directly controlled by a human operator, in actuality there are still many functions that require human direction.

Planning is key to enabling autonomous systems whether they are biological or artificial intelligence (AI) agents. In general, planning involves an interaction between a platform's actuators and its desired goals. This largely includes generating a detailed description of actions to be taken to accomplish a set of goals. In order to truly be autonomous, any system must further have the ability to plan and then monitor the execution of its plans, to re-plan when necessary, to determine goals, and to coordinate activities with other agents.

Sophisticated planners are available, but still require some degree of manual control, such as highly detailed pre-mission designated task lists. Thus, although autonomous and automated operations of UAVs have been studied for decades, such operations are still manpower intensive and/or permit minimal replanning as situations change. Of interest are autonomous planning approaches that 1) resolve conflicting information, 2) plan, and 3) learn.

Guiding this is the understanding that true autonomy has three characteristics: 1) intelligent, informed, unforced choice, 2) an ability to handle uncertain and unexpected situations, and 3) a sense of self or self-direction/tasking. These three features of autonomy are commonly identified across a wide set of diverse fields of study, including philosophy, psychology, law, government, robotics, cognitive science, and artificial intelligence (AI).

In biological systems, these characteristics developed over a long time to address the richness of the world. To build synthetic automatons with these capabilities at realistic time scales, complex modeling and simulation (M&S) is required. A good M&S evaluation shows that an agent can make good choices, act robustly in the face of environmental variations, and successfully operate as a distinct entity within a group of cooperating and/or competing agents. Because there are many combinations of situational elements that make-up a complex scenario, only M&S can provide the large numbers of simulations that are necessary to ensure that agents are robust and flexible.

Before deployment, an autonomous agent must be rigorously tested and evaluated to understand its decision spaces and to develop performance expectations. Though there has been some discussion of explainable AI, the complexity of the decisions being made by an autonomous agent and the tempo of its mission might preclude understandable explanations in some situations. Thus, M&S for developing trained and trusted autonomous agents is of interest herein; this can be thought of in much the same way as service dogs that, though trained, tested, and trusted, are not queryable. However, the research herein focuses on symbolic methods that might provide the data that are needed to construct such explanations. Together, it is hoped that some combination of explanation and testing will be sufficient for certification.

Here, UAV dynamic and autonomous goal/task flexible operations of UAVs in various environments are traversed and declarative data are gathered. Results from sensing operations are considered by a probabilistic decision agent to determine the course of action multiple UAVs should pursue. In the proposed methodology, all UAV actions are autonomously selected by a central controller such as a primary UAV in the swarm. Human operator input is not necessary beyond the initialization of the mission with the selection of goal conditions.

AI involves a complex interaction of algorithms, software, hardware, applications, and data. Finding the correct algorithms in the proper combinations is not as easy as some early researchers expected. Because of the generally reprogrammable nature of the underlying computer hardware, the space of possible algorithms is immense. In response to this difficulty, AI research has focused largely on methods that are mathematical, statistical, and rule-based in nature, to quickly address narrow, but very useful applications. AI can be grouped in a rough taxonomy by the nature of each innovation. Broadly, AI research is either application based, where a known algorithm is applied to an application, or theory based, where researchers develop, characterize, or expand algorithms to address classes of computational problems. Areas of theory-based AI approaches include those that develop attributes largely viewed as necessary for intelligent behavior. These areas include: reasoning, knowledge representation, planning, learning, human-computer interaction, and integration. These areas include further overlap with other domains, i.e. human-computer interaction overlaps with robotics and reasoning overlaps with neuroscience and cognitive architectures.

Related to true AI are autonomous capabilities. To understand what is meant by autonomy, we must understand the current state of the art for machine intelligence and how it relates to automation and autonomy. For this purpose, we will consider the following definitions, adapted from: Automation is where a system functions with little to no human involvement, but with well-defined tasks with predetermined outcomes. Autonomy is where a system has intelligence-based capabilities, allowing it to respond to situations that were not preprogrammed or anticipated in the design. Central to these distinctions is that an autonomous system can select an appropriate task or goal to pursue, modify its thinking constructs, and appropriately assume roles. Selecting the appropriate task or goal to pursue further implies reasoning, including planning capabilities that leverage models of the self and of the environment.

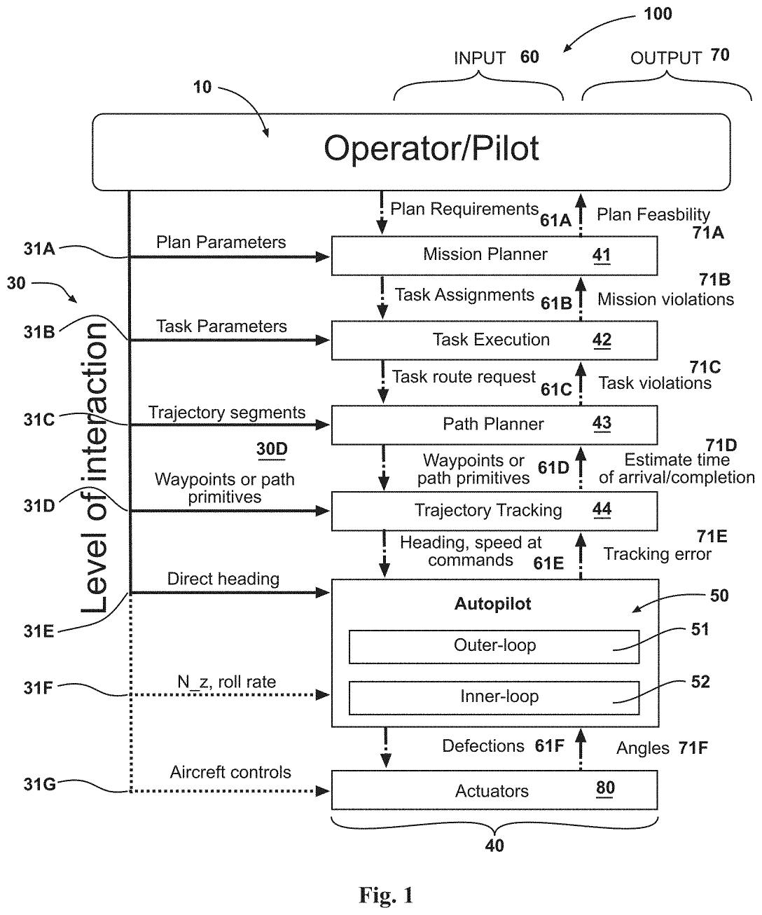

Planning is a pervasive problem for robotics and for UAVs, it is also central to many autonomous capabilities. Planning involves a hierarchy of terms and functions which range from the highest level of mission planning down-to the lowest level of determining forces to apply to specific vehicle actuators. The general conceptualization of planning as a protocol stack is presented in FIG. 1. Here, we present planning as a hierarchical relationship between an operator/user and the actuators. This encompasses the breadth of planning, e.g. in robotics planning describes control of motion, whereas in artificial intelligence planning is more abstract and implies a set of tasks or actions. When a plan is executed, the proper sequencing of actions are expected to make the agent reach a goal, usually by improving some value function of the problem state. At each increasing-level of the planning stack, a planner operates on an increasingly abstract notion of state to achieve an increasingly general objective. Overall, plans and planning can be thought of per the following definitions:

A plan is defined as a detailed description of actions to be taken by one or more entities to accomplish a set of goals.

Planning means to generate the plan. This generation is subject to a set of constraints that limit the plausible choices of actions.

FIG. 1 is a diagram of an exemplary planning stack process 100. The planning stack 100 interactively provides adjustment and feedback to an operator 10 at levels of interaction/planning 30 to improve the overall mission planning which includes the arial vehicle navigation and tasking, and the like. Generally identified as planning

planning process. The level of interaction is herein illustrated from a broad to narrow element of planning, but each step may be repeated, skipped or done in any order as determined by a hardware and/or software analysis 40. A level of planning/interaction 30 between the process 100 and the operator 10 may include multiple levels as determined by the AI and/or the operator. As illustrated in FIG. 1 levels of planning/interaction 30 may include plan parameters 31A, task parameters 31B, trajectory segments 31C, waypoints 31D, heading 31E, roll rate 31F, controls 31G where the aircraft controls 31G include propulsion, and control surfaces such as ailerons, elevators and rudder. As illustrated in FIG. 1 a Hardware & SW Analysis 40 interaction is also herein illustrated from a broad to narrow element of planning, but each step may be repeated, skipped or done in any order as determined by a hardware and/or software analysis 40 (in sequence, in parallel or as each changes). An analysis 40 may be performed or implemented by a mission planner 41, a task execution 42, a path planner 43, a trajectory tracking 44, an autopilot 50, an actuator 80, and the like. As illustrated, the autopilot 50 may include an inner loop 51 and an outer loop 52 where the outer loop 51 may be reviewing planning and mission performance the inner-loop 52 may be annualizing the specific aircraft flight parameters to meet the immediate flight operations requirements. The hardware and software analysis 40 is preferably in communication with the operator 10.

Each software and hardware analysis receives an appropriate level of planning/interaction 30 and inputs 60, resulting in an output 70 communicated to the operator 10. As illustrated in FIG. 1 at the plan parameter 31A level of interaction 30, plan requirements 61A are provided to the mission planner 41, which provides back to the operator 10 an output 70, in this example a plan feasibility 71A. Similarly at the task parameters 31B, task execution 42 analysis tasks assignments 61B are provided to provide the operator 10 with an output of any mission violations 71B. As illustrated in FIG. 1 at the task parameter 31B, a task assignments 61B are provided to the task execution 42, which provides back to the operator 10 any mission violations 71B and plan feasibility 71A. Similarly at the task parameters 31B, task execution 42 analysis task assignments 61B provide the operator 10 with an output of any mission violations 71B. At the trajectory segments 31C, a task route request 61C is provided to the path planner 43, which provides any task violations back to the operator 10 71C. Similarly, at the waypoints 31D, waypoint(s) 61D may be provided to the trajectory tracking 44 to provide an estimated time of arrival/completion 71D. At the direct heading 31E, heading and speed 61E may be provided to the autopilot 50 which provides any tracking errors 71E back to the operator 10. At the roll rate 31F level, the autopilot outer-loop 51 and/or inner-loop 52, heading, speed 61E, and roll information may be provided to the autopilot 50 which provides any tracking errors 71E back to the operator 10. At the aircraft controls 31G level of interaction, the aircraft actuators 80 use deflection data to adjust and/or report aircraft angles 71E.

For the purposes of this research, planning is considered as occurring between an operator 10 and a vehicle autopilot 50 (FIG. 1). Of particular interest are mission and task planners that are given abstract goals. The planners must determine the tasks, schedule of tasks, and allocate resources to achieve these goals. In operation, as conceptualized in FIG. 1, a mission planner selects tasks, determines the organization of each task, and then employ tasks planners to complete the plan.

At a high level, a mission is a set of tasks. Each task can be viewed as a tree structure that decomposes the task into subsequently finer levels of detail. The leaves of the tree are basic actions that are directly executed by vehicles, sensors, and other assets. The required actions usually include driving the vehicle, so a path planner generates waypoint paths. Planning also involves some scheduling to ensure that tasks are coordinated and accomplished at the appropriate times. It also includes asset allocation to assign vehicles, weapons, sensors, and other resources to each task. Mission planning can become a complicated set of intertwined sub-planning efforts. Iterations are often required to resolve the interdependency of the various planning functions.

When the events of the real world do not match the expectations of the planner, changes to the plan are often needed. The solution to this problem is known as plan revision and replanning. Plan revision attempts to address a discrepancy with minimal modifications to the existing plan. Replanning involves major modifications and may even begin with a clean slate, including new objectives. Small discrepancies, e.g. unexpected obstacles, in expectations are handled by revision planning at the lower-levels of the planning stack (FIG. 1). Large changes to the environment, such as a missing target or a pop-up threat, may require task changes. Very small unexpected events, such as a wind gust, might not need replanning at all if the autopilot is sufficiently robust. However, accumulated, small, unexpected events, such as frequent wind gusts, may impact resources, such as fuel, and therefore require resource reallocation or even task replanning.

An autonomous artificial agent is expected to make proper choices within uncertain and unexpected situations in a flexible manner. It is important for the agent to select appropriate actions, to modify its thinking constructs, and to appropriately assume roles. For a UAV application, these high-level, cognitive functions are supported by the functions of asset allocation, scheduling, trajectory generation, flight control, obstacle avoidance, and sensor data exploitation. While still considered as planning, these low-level functions have been automated for decade

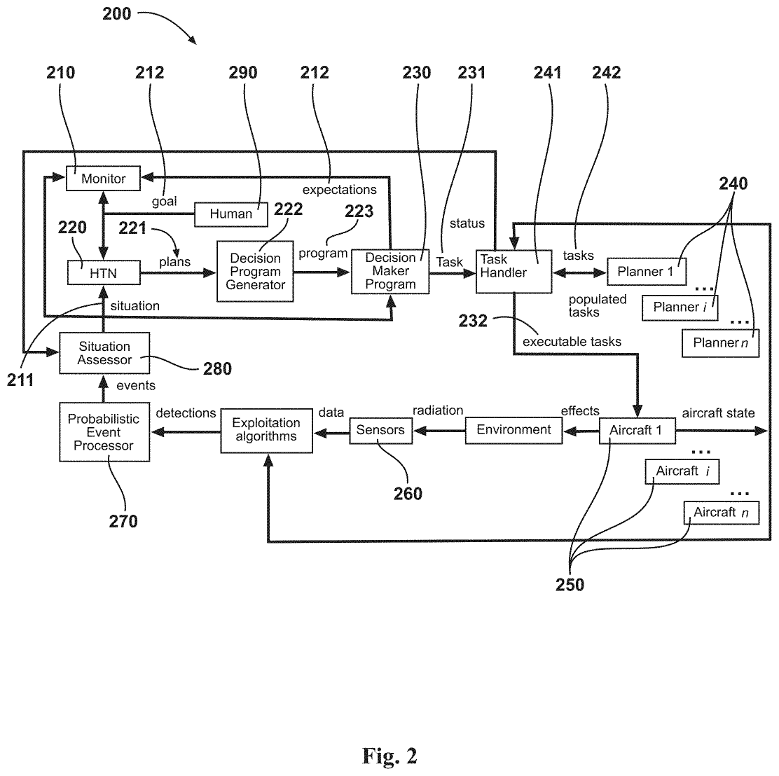

FIG. 2 depicts a diagram of conceptualization of a dynamic replanning autonomy system (DRAS) process 200. The Dynamic Replanning Autonomy Service (DRAS) is an autonomy component that prosecutes a mission by choosing situation-appropriate tasks in response to events. This system includes a status monitor, a Hierarchical Task Planner (HTN) 220, a decision maker 230, at least one low-level planner 240, at least one aircraft 250, at least one sensor 260, a probabilistic event processor 270, and a situation assessor 280. In the top-left corner of FIG. 2 is an automated monitor 210 that is apprised of the goal of a human operator 290. The monitor 210 watches an evolving situation 211 and also considers expectations 212 that are generated by the decision maker program 230. The monitor 210 may trigger the HTN 220 to replan if expectations 212 are not being met. The HTN generates multiple plans 221 for achieving a goal 212 from the initial state. These plans 221 are evaluated by a decision program generator 222 and is generated through a software program 223 which consists of software that provides a decision program 230 which identifies and selects tasks 231 for the task handler 241 to convert to executable tasks 242 that are assigned to planners 240; and/or executable tasks 232 supplied to aircraft 250. DRAS includes two approaches to autonomous planning: the Brute-Force Replanning Manager and the Machine Cognitive Replanning Reasoner. The Brute-Force Replanning Manager provides autonomous tasks selection via an expert system that switches between planners. Planners are considered to be modules in this system and this includes the options of typical AFRL planners, i.e. UxAS (RQ): Unmanned Autonomy Services, and SHOP (RI): Simple, Hierarchical, Ordered Planner. The Brute-Force Replanning Manager evaluates the sensor data and mission objectives and determines if an agent can or cannot achieve the initial planned effect. If the agent can achieve a planned effect, the current planner is continued in use. If the agent cannot achieve a planned effect, then the Brute-force Replanner switches the task switches Planner (task flexibility demonstrated).

The tasks may be passed from the decision maker to a task handler. This handler manages each task command through its entire life cycle. The task handler is based upon a subsystem architecture, where subsystem receives messages that can represent task commands or other data. In the present implementation, these messages are formatted using the Lightweight Message Control protocol (LMCP). each subsystem includes a routine for receiving task commands as messages, a queue where the messages are immediately stored for later processing, and a processing routine. The subsystems share a memory and a pulse function. Task commands are stored while they are between processing stages. For example, after planners are queried, a task command will reside in this memory until a plan is returned from a planner. This memory is important because it allows the subsystems to avoid waits. Instead, they simply store a task command until a required response is received. When the response message arrives, it is associated with a task command and that task command is retrieved from the memory. All subsystems have access to this memory.

The processing routine implicitly implements a state machine that moves task commands through a life cycle of successive operations. Each task command object stores its complete state, so it is possible for the task handler to manage any large number of task commands at the same time. Data locks are implemented to facilitate multiple processes. The pulse function revisits incomplete or failed operations at a fixed interval. Recovery is implemented for foreseeable failures, such as temporarily unavailable resources. The major subsystems of the task handler are an executor, a canceler, and a monitor. The executor receives task commands. In stages, the executor queries the resource allocator, then it plans, and then it activates the plans. Activation includes passing the plans to an autopilot. Upon successful activation, the executor passes the task command to the monitor. The monitor assesses the state of the agents against the plan as the autopilot implements the plan. When the plan is complete or failed, the associated task command it is sent to the canceler as the task commend reaches the end of its life cycle. The canceler deallocates (frees) resources and stores the task command into a historical memory. Other subsystems include a mission plan handler, which communicates with the executor, sending commands and receiving status. Another important subsystem is the resource manager, which allocates and deallocates the resources, such as aircraft and sensors, that are needed to perform a task.

Task flexibility is an element of autonomy which this invention addresses by applying more than one planner. Each planner is designed to operate over unique conditions and it produces unique results. As such, there is no one best planner. In fact, the well-known “No Free Lunch” theorem proves that there can be no one best planner, no matter how much one tries to improve a planner's total coverage of conditions. To address this difficulty, the idea here is to combine planners to achieve a more comprehensive capability.

Each planner can be described by a data schema, although this schema is sometimes implied (e.g. neural network), rather than explicitly described (e.g. A* planner). Each schema can be represented by a tree that defines the data that the planner will process and the data that it will produce. In the case of planners, the inputs are situational descriptors and tasks to perform within those situations. The output data are plans that allow the agent(s) to solve those tasks. The schema describes the conditions under which the planner operates and what it can do. So, a larger schema tree implies a greater flexibility over the tasks that can be solved.

For example, the Open Missions Systems (OMS) Universal Command and control interface (UCI) 2.0 schema is very large, too large for any single organization to describe a completely comprehensive planner. It is presumed that various organizations will develop planners that cover those portions of the schema that they highly prioritize. Because priorities differ and no one organization can possibly cover the entire schema tree, the union of all the smaller schema trees will cover a greater part. If one defines the extent of coverage of the UCI 2.0 tree as task flexibility, then the combination of planners produces greater task flexibility. Furthermore, just because two planners share some portions of the schema tree does not mean that they will perform similarly over these shared portions. They may use different algorithms, each with relative merits. In these regions of overlap, there are opportunities for increasing performance by combining the results.

The task handler 241 may includes a selection mechanism. (aka “selector”). The selector receives one or more tasks, data that describe the situation under which the tasks must be implemented, any constraints, and a set of objectives. Constraints describe things that the planner is not allowed to do, such as to suggest that an aircraft enter a no-fly-zone. Objectives are functions that describe the goodness of a plan. For example, one objective function might measure total fuel use, with less fuel being better. Another example is the number of targets that are adequately located and characterized. Some objective functions measure an end state, such as the number of saved vehicles. The selector chooses one or more planners that are expected to operate adequately within the situation. The selector passes task, situation, and constraint data to the planners. Each planner returns a plan. The selector chooses the best plan according to its objective functions. Optionally, the selector may evaluate subsets of each plan and then recombine the best subsets into a single plan that is better than any single plan.

This combing of plan parts is achieved in the following fashion. It is unlikely that any single plan will completely dominate all the other plans with respect to all objective functions. Therefore, the selector attempts to recombine the plans into a single, better plan. First, decentralized portions of plans are identified. A portion of a plan is decentralized if it represents a set of actions with independent dependencies. Then, each portion is evaluated against all the objective functions. The selector reassembles a plan that dominates the individual plans.

The plan selector may operate within a replanning context by initializing a planner with an present plan. The initialization is possible because the task handler stores the present plan with each task command. When a task replanning trigger is activated, the present plan is retrieved and passed to the planners. Because many of the elements of the present plan will remain valid, the planners are likely to revise the plan faster than they could generate a plan from scratch. The selection process operates over replans just as it would over from-scratch plans.

This decision maker program 230 triggers tasks, based upon the present situation. The program consists of a set of probabilistic rules that map states to appropriate tasks, as well as expected post choice conditions. Decision rules are prioritized using value information that is determined by the HTN 220. The tasks are passed from the decision maker to a task handler. This handler 241 passes individual tasks to appropriate low-level planners for asset selection, scheduling, and route generation. The best planning service is selected for each particular task. Fully populated tasks are returned to the task handler. Each task is passed to the aircraft 250 via aircraft guidance systems. As the aircraft move, they detect objects with their sensors. These detections are probabilistic, so they are passed to a probabilistic event handler that evaluates the probability of each relevant event. Event probabilities are passed to the situation assessor and combined with status information to maintain a state vector.

The Hierarchical Task Network (HTN) 220 may be any high level planner such as SHOP++, an extension of the Python version of the Simple Hierarchical Ordered Planner (SHOP). The SHOP++ is an HTN 220 that builds on the basic ideas of PySHOP, while including advanced deterministic search features. SHOP++ is contingency aware, meaning that it understands that tasks may not achieve their expected postcondition. Therefore, it generates many plans. SHOP++ allows a user to describe primitive tasks in terms of transitions from preconditions to postconditions. Each precondition describes a state of some system to which the task is applicable. Each postcondition describes how a task can transform that state. Both preconditions and postconditions are specified as general Python program strings, so virtually any state representation is supportable and virtually any transformation function may be implemented. SHOP++ uses a double-ended queue to perform a tree search for solutions. It finds viable sequences of tasks that transform an initial condition into a goal condition. Like other HTNs, methods allow the planner to achieve in a single iteration what would ordinarily require a search of many branches. Methods are collections of primitive tasks. SHOP++ builds its methods as it discovers them during the planning process.

SHOP++ is contingent. The search will find multiple possible solutions when multiple possible postconditions are supplied for the tasks. A set of two or more postconditions represents the various ways that a task may transform the state. The first postcondition is expected when the task is executed properly. The other postconditions represent non-ideal states that might occur if something goes wrong. These possibilities are prioritized and probability values may be provided if they are available. The search will find additional paths that include the off-nominal conditions, allowing the system to handle these contingencies. The priorities and probabilities are used to modify the values of tasks, thereby ordering the deterministic search without explicitly resorting to probabilistic search methods. In this way, the most important contingencies are considered first in case the planner hits a time limit.

The purpose of the decision maker program 230 is to quickly drive a succinct action policy, by issuing task commands for subsequent execution as actions. The decision maker 230 avoids complicated replanning within the agent's primary loop. Fast execution is necessary for timely responses to quickly changing conditions.

The process is analogous to an athletic game, where a coach deliberates and builds a succinct play from a set of template actions. The play is then executed in real time by the players. Using a sports analogy, in this system, SHOP++ is the coach and the decision maker and downstream components, including the task hander and the low-level planners, stand in the place of the players. The decision program that comes from SHOP++ via the program generator is the play.

The decision maker is an automation routine that monitors the situation in real time and selects any task that is appropriate for the conditions at hand. It is similar to a rule-based system, but it evaluates conditions with Python program strings, not just comparison operators or distance measures. The decision maker is probabilistic so it handles an uncertain assessment of the situation. The decision maker annotates the task with information that informs the task handler about details, such as the area where the task is to be applied. The decision program returns a nominal expectation, which is the most probable postcondition that will arise if the task is successfully executed. This postcondition is used by the monitor to make sure that the task is successfully executed. The decision program runs in real time, making the agent much faster than if SHOP++ were placed within the decision loop.

Decision Program Generator. The Decision Program Generator (DPG) converts a set of plans from SHOP++ into a Python program for the decision maker. Tasks within the SHOP++ plans become the tasks of the decision-making program. The preconditions of the SHOP++ tasks become the triggers for the decision program's tasks. The postconditions become the expectations that are produced by the decision program. The plan values that are determined by SHOP++ are used to prioritize tasks. The result, in a perfectly deterministic world, is the equivalent of a state machine that executes the plans. If all the preconditions transform to the expected postconditions then the nominal plan will be executed. If the state transforms in an unexpected fashion then contingent tasks are available. In a probabilistic world, the decision program exhibits considerable flexibility over a state machine because it can operate even in the presence of unexpected state transitions.

Probabilistic Event Processor. The Probabilistic Event Process (PEP) presently accepts probabilistic classifications from one or more sensor exploitation algorithms. It computes the probability of each event as an expression of class counts in disjunction normal form. For example, one can define an event as “(two or more sedans and one or more trucks) or (no vans and between three and four motorcycles)”. The algorithm accumulates probabilities of possible combinations of object counts, making it potentially computationally complex. However, there are features that speed execution greatly. First, the PEP assumes the independence of detections and a closed-world assumption is included, reducing the possible combinations of objects that must be considered. (Conditional probabilities could be considered if they were available.) Second, the software orders the combinations according to decreasing probability, so that results may be approximated by truncating the process after accumulating only a small subset of the total collection of combinations.

A general set of predicates is planned for the PEP. These predicates will operate together with the object counts to provide more general descriptions of events. In addition, the PEP will be recursive, providing hierarchical descriptions as events of events.

In order to assess the autonomy of the developed framework, an appropriate M&S scenario, or challenge, is needed. This needs richness and complexity in the scenario or else it could be solved with a much simpler system.

Search and Rescue Richness and Complexity and Performance Metrics: During search and rescue missions, autonomous agents could conceivably accept dual tasks: primarily searching for cars and hazards, which we call fiducials, as well as directly rescuing cars by dissuading them from traveling on dangerous roads. For illustrative purposes, we will assume that an agent can immediately apply all its assets to dissuade known cars from known hazards. However, the situation is dynamic and cars can enter and exit the scenario as hazards expand, start, or contract. Therefore, an agent must use some of its assets to search the environment to keep its assessment of the situation up to date. To assess how well the agent handles these dual tasks, three metrics were constructed. These metrics include, the vehicle detection efficiency:

ε_{VD}=N_{VD}/N_{V} (1)

where N_{VD} is the number of vehicles detected and N_{V} is the number of vehicles. The fiducial detection efficiency:

ε_{F}=N_{FD}/N_{F} (2)

where N_{FD} is the number of fiducials detected and N_{F} is the number of fiducials. And, the danger to vehicles:

D_{V}=N_{VC}/N_{V} (3)

where NVC is the number of vehicles that cross a fiducials and NV is the number of vehicles, which assess how well the agent is dissuading cars from hazardous areas, we developed one more metric. Two objectives are to maximize each detection efficiency. The overriding objective is to minimize danger to the vehicles, under the assumption that vehicles will be saved.

Since real world missions do not often have a specified ending, as the truth is never fully known during the mission, neither should sufficiently complex simulations. Thus, simulation should also include these two characteristics. Therefore, metrics that measure the goodness of the state at the end of the mission or that measure the total time of the mission have no meaning during an operation. Such metrics are only meaningful after a mission is complete and only if an appropriate assessment of the end-state is possible. The benefit of metrics (1)-(3) is that, by recomputing at intervals and averaged over a long period of time, we can assess how well an agent is performing the exploration task. The metrics (1) and (2) additionally have the benefit of being bounded between 0 and 1. They are measurable during the performance of a mission, yet they correlate well with the desired end-state, which is a larger number of saved assets.

A new approach to autonomy is presented to achieve useful behaviors within a complex environment. The automaton applies a high-level planner to select the correct task elements for the conditions and the goal at hand. As a first step towards handling unexpected situations, the planner considers contingent state transitions. The plans are used to generate a decision agent that intelligently chooses appropriate actions in response to changing conditions.

The agent addresses the complexity of the environment by separating modes of “thought” across two time scales. The planner provides deliberation on a slow time scale where it can perform complex planning while potentially considering many task elements, situation variables, and goal conditions. Because this planning can be too complicated to run in real time, the resultant plans are converted into a decision program.

Herein, “planning” is considered as the creation of plans by computer software. While seemingly self-defining, subtleties exist in the terms “plan” and “planner”. The word plan is defined as a detailed description of actions to be taken by one or more entities to accomplish a set of goals. The word planning means to generate the plan. This generation is subject to a set of constraints that limit the plausible choices of actions. When the actions are performed, they are expected to achieve a goal, which is some value function of the problem state. A planner is considered to be a software process or set of inter-connected processes that develops plans based on user input, a knowledge state of the environment, and the ontology of entities under consideration. In order to create plans, planners use algorithms, which are a logical process for solving a well-defined subset of a planning problem. Thus, an algorithm is a piece of a planner, but not the entire planner; a planner can contain multiple algorithms.

Planning is a multi-disciplinary field which can involve robotics, control theory, artificial intelligence, algorithms, computer graphics, operations research, supply chain management, and logistics.

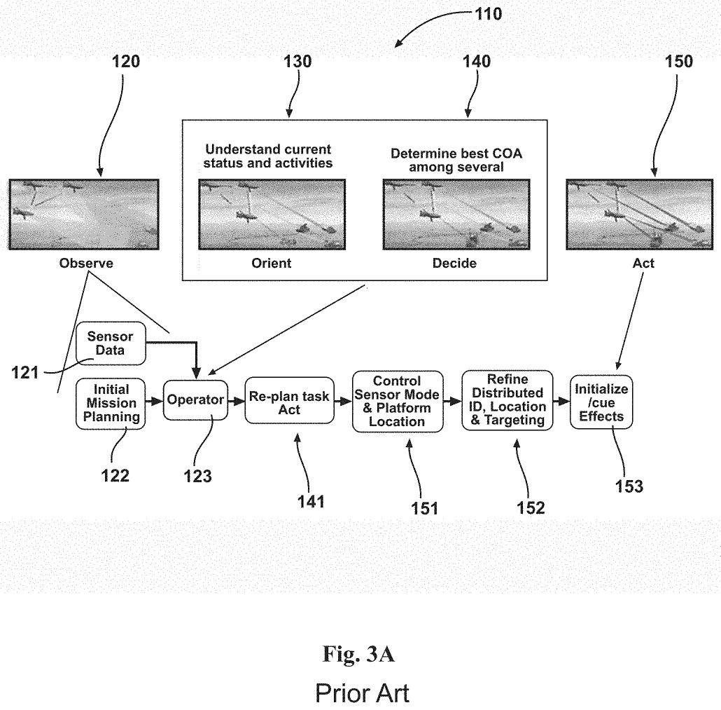

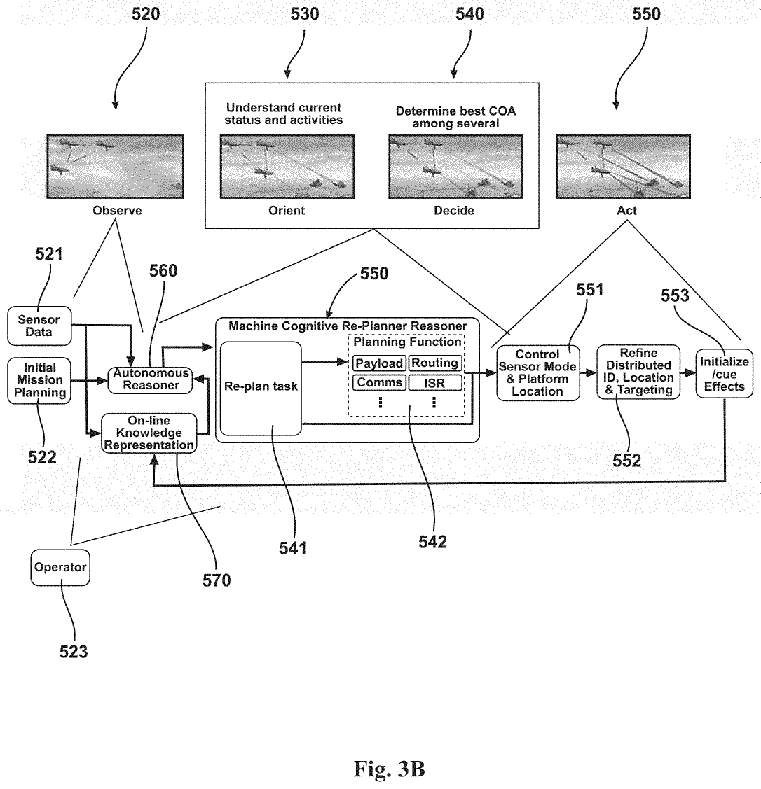

FIG. 3A depicts a diagram of prior art planning and replanning processes 110 illustrated within an Observe 120, Orient 130, Decide 140, Act 150 (OODA Loop) loop and are heavily reliant on man-in-the-loop demands and not flexible-to-future autonomous needs. These include having the following Key Technical Gaps:

(i) Task Flexibility: UAS currently operate within a narrow set of tasks (ISR UAVs do not change roles), and needs course of action generation across the whole space of UAS potential actions;

(ii) Autonomy in Denied Comms: resilient to unexpected, self-coordination algorithms;

(iii) Interoperability of Planners: Planners include Machine Learning, Game Theory, etc. etc. with each considering different decision spaces; and

(iv) Reasoning and Cognitive Flexibility: Onboard reasoning to deliberate over sensor data, memories, potential results, and planning options to achieve an effect and a learning pattern of life.

As illustrated in FIG. 3A at the observe 120 phase, sensor data 121, and an initial mission planning process 122 begins with an operator 123. As information and understanding evolves during the orient 130 phase, further input is provided to the operator 123. During the decide 140 phase replanning 141 takes place as part of the Decide phase 140 where action 150 may change the aircraft location 151, change a target 152, or a combination thereof to have the effect 153 desired.

FIG. 3A depicts the diagram of a Brute Force Replanning Manager. The Machine Cognitive Re-Planning Reasoner provides a high level of task flexibility with broad goals. This incorporates a learning system which determines the plan and a planning approach from experiences and M&S. This approach considers planning operations as services rather than different paradigms. The operator is moved to be on-the-loop and monitoring the process at an executive level, rather than in-the-loop and determining suitability of waypoints and operations. Operations include a feedback loop that includes world data storage (On-line Knowledge Representation) and a machine cognitive reasoner (autonomous reasoner) which can adjust decision thresholds as knowledge is learned, and live M&S is performed to explore potential effects by performing various actions.

FIG. 3B depicts an illustration of the replanning process incorporating a Machine Cognitive Replanning Reasoner 580 where an OODA loop of Observe 520, Orient 530, Decide 540, and Act 550 is driven by an autonomous reasoned 560 and the Machine Cognitive Replanning Reasoner 580, which relieve some of the decision burden from the operator 523. The operator still begins operations with initial planning 522 and sensor data 121 in the observe phase 120 but the autonomous reasoned 560 and the machine cognitive re-planner reasoner 550 handle programmable decisions. The machine cognitive re-planner reasoner 550 may include replanning tasks 541 and/or a dynamic replanning autonomy service (DRAS) 542, controlling the sensors feedback of knowledge 570 and refining aircraft location and/or targeting 552. An “inner loop” of action before final mission action 550 and the associated specific actions 553 occur.

As illustrated the observation phase locates and identifies requirements such as support equipment, using sensor date, initial mission planning from the operator, an autonomous reasoner and on-line knowledge representations. The orient phase of FIG. 3B seeks to understand the current status of ongoing activities while the Decide phase determines the best course of action among the alternatives. The Orient and Decide phases overlap with using the Machine Cognitive Re-planner Reasoner to re-plan tasks regarding payload, routing, communication and the like. During the final Act, phase operations are executed, controlled, and refined to achieve the desired outcomes. The operations are repeated as needed to achieve improved outcomes.

The autonomous reasoner selects an appropriate task and adapts logic to determine planner selection (cognitive and task flexibility demonstrated). This approach deliberates over sensor data, memories, potential results, and planning options to achieve an effect, and learns a pattern of life. Planners here are considered to be functions or black-boxes and employed as needed. In operation, the cognitive reasoner selects an appropriate task with adaptive logic used to determine when a planner is selected (cognitive and task flexibility demonstrated) E.g., a swarm of sensing UASs determine they cannot return to base and switch their mission to kinetic effect.

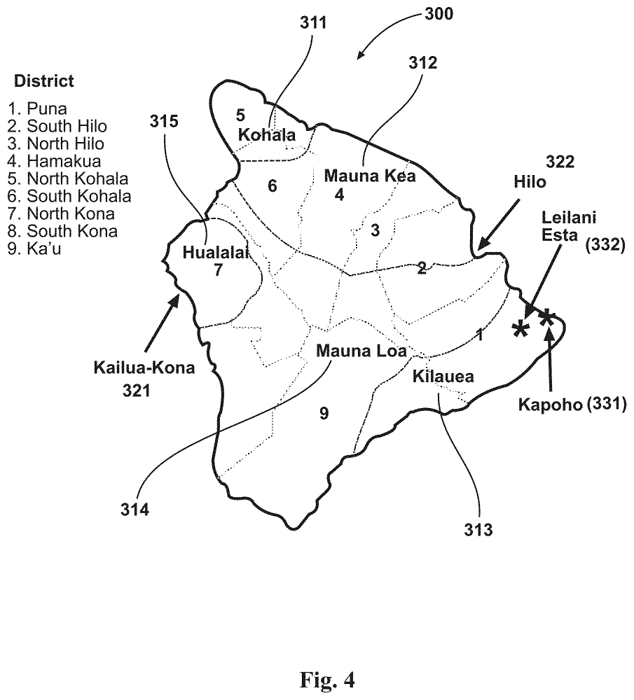

FIG. 4 depicts an exemplary simulation with a map of the Big Island of Hawaii 300 with 9 districts Puna 1, South Hilo 2, North Hilo 3, Hamakua 4, North Kohala 5, South Kohala 6, North Kona 7, South Kona 8, and Ka′u 9. Also illustrated are five volcanos a Kohala 311, a Mauna Kea 312, a Kilauea 313, a Mauna Loa 314, and a Hualalai 315. Also illustrated are reference points for Kailua-Kona 321 and Hilo 322.

[This scenario was taken from the 2018 volcano eruptions on the Big Island of Hawaii.] Beginning on May 3, 2018, earthquakes and spewing lava began disrupting regular life in lower Puna on the Big Island of Hawaii. This eruption notably occurred in the Leilani Estates 332 subdivision and the community of Kapoho 331, with the result being the destruction of many homes and farms. If UAVs had been available for search and rescue operations in the 2018 eruption, our simulation indicates the present invention might have saved lives by better performing general tasks such as reconnaissance, dissuasion, and rescue.

The eruption spanned May 3 through September 4 and involved 13.7 square miles of land being covered with lava, destroyed 700+ homes, and 1.36 square miles of new land was created in the ocean. SLAMEM was used as the modeling environment. SLAMEM is a simulation environment built by Toyon Research Corporation with a primary focus on simulating intelligence, surveillance, and reconnaissance (ISR) missions for mobile targets. Thus, tracking, vehicle movement, identification, and ISR missions by UAVs are standard tasks for SLAMEM simulations.

The automation for the Hawaii 300 scenario is described by three primitive tasks, with each of these tasks having a single precondition and one, two, or at most four postconditions. Additionally, there is a completion task. This completion task will never be executed by the decision maker, because the absolute certainty requirement will never be received, but some condition is necessary for the SHOP++ plans to terminate. By the end of the simulation at 1,196 seconds, 40% of the 20 ground vehicles are destroyed when there is no aid from the autonomy system. With the autonomy system in place, only 20% of the ground vehicles are destroyed.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

In the preceding detailed description of exemplary embodiments of the disclosure, specific exemplary embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical, and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various requirements are described which may be requirements for some embodiments but not other embodiments.

It is understood that the use of specific component, device and/or parameter names, and/or corresponding acronyms thereof, such as those of the executing utility, logic, and/or firmware described herein, are for example only and are not meant to imply any limitations on the described embodiments. The embodiments may thus be described with different nomenclature and/or terminology utilized to describe the components, devices, parameters, methods, and/or functions herein, without limitation. References to any specific protocol or proprietary name in describing one or more elements, features or concepts of the embodiments are provided solely as examples of one implementation, and such references do not limit the extension of the claimed embodiments to embodiments in which a different element, feature, protocol, or concept names are utilized. Thus, each term utilized herein is to be given its broadest interpretation given the context in which that term is utilized.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. An autonomous mission selection process for improving performance, the process including:
using an Observe, Orient, Decide, and Act model wherein;
sensors are used for observing a situation and guiding initial mission planning;
a machine cognitive re-planner assesses inputs, orients, and replans operations including deciding on a payload and determining a route;
autonomously acting to direct the mission selected.

2. The autonomous mission selection process of claim 1 wherein the machine cognitive re-planner uses a brute-force replanning manager, the process including:
a selection subsystem that includes:
a mechanism for providing input data to multiple planners;
a mechanism for receiving and interpreting the plans that are output by these planners;
a mechanism for comparing and/or contrasting the plans
a mechanism for ordering the plans from most desirable to least desirable
a mechanism for switching between plans and/or planners in real time to change mission operations.

3. The autonomous mission selection process of claim 1 wherein the machine cognitive re-planner uses a planning stack, the process including:
a selection subsystem that includes:
a mechanism for providing input data to multiple planners;
a mechanism for receiving and interpreting the plans that are output by these planners;
a mechanism for comparing and/or contrasting the plans
a mechanism for ordering the plans from most desirable to least desirable
a mechanism for switching between plans and/or planners in real time to change mission operations.

4. The autonomous mission selection process of claim 2 wherein the machine cognitive re-planner uses a decision maker program.

5. The autonomous mission selection process of claim 2, where portions of different plans are selected and combined into a complete plan.

6. An autonomous arial vehicle planning system including:
beginning a vehicle mission with initial planning using sensor data and observing the current situation,
using a machine cognitive replanning reasoner providing an autonomous reasoner which reasons based up repeated observing, orienting, deciding and acting independent from an operator to update the vehicle mission navigation and tasking;
the machine cognitive re-planner reasoner including a dynamic replanning autonomy service (DRAS) for replanning tasks, controlling the sensors feedback, refining an aerial vehicle location and refining a target location.

7. The autonomous arial vehicle planning system of claim 6 wherein the machine cognitive replanning reasoner includes a second process run before a final mission action.

8. The autonomous arial vehicle planning system of claim 6 wherein the planning includes navigation and tasking.

9. The autonomous arial vehicle planning system of claim 6 wherein the level of planning is determined by the operator.

10. The autonomous arial vehicle planning system of claim 9 wherein the level of planning includes at least one plan parameter, at least one task parameter, at least one trajectory segment, at least one waypoint, at least one heading, and at least one roll rate.

11. The autonomous arial vehicle planning system of claim 9 wherein the planning system controls the arial vehicle.

12. The autonomous arial vehicle planning system of claim 9 wherein the arial vehicle controls include propulsion, and control surfaces.
